(19) United States
(12) Patent Application Publication
(10) Pub. No.: US 2020/0300206 A1
(43) Pub. Date: Sep. 24, 2020

(54) OUTDOOR POWER EQUIPMENT WITH ELECTRONIC START

(71) Applicant: BRIGGS & STRATTON CORPORATION, Wauwatosa, WI (US)

(72) Inventors: Jeffrey ZEILER, Wauwatosa, WI (US); Robert KOENEN, Wauwatosa, WI (US); Jason HANSEN, Wauwatosa, WI (US)

(73) Assignee: BRIGGS & STRATTON CORPORATION, Wauwatosa, WI (US)

(21) Appl. No.: 16/755,750

(22) PCT Filed: Oct. 17, 2018
(86) PCT No.: PCT/US2018/056330

§ 371 Date: Apr. 13, 2020

Related U.S. Application Data
(60) Provisional application No. 62/574,167, filed on Oct. 18, 2017.

(51) Int. Cl. F02N 11/08; F02N 3/02; A01D 34/68

(52) U.S. Cl. CPC F02N 11/087; F02N 3/02; A01D 34/76; A01D 34/6818; F02N 2200/022; F02N 11/0862

(57) ABSTRACT

An apparatus including an internal combustion engine, an electric motor configured to start the internal combustion engine, a brake mechanism, a release mechanism movable to a first position to release the brake mechanism, a switch actuated by the release mechanism, a pull rope, a sensor configured to output a signal based on the pull rope being actuated, and a control module coupled to the switch and the sensor. The switch is configured to provide a switch input to the control module when the release mechanism is in the first position. The sensor is configured to provide a sensor input to the control module when the pull rope is actuated. The control module activates the electric motor in response to the switch input and the sensor input.

### CROSS-REFERENCE TO RELATED PATENT APPLICATIONS

This application claims the benefit of U.S. Provisional Application No. 62/574,167, filed Oct. 18, 2017, which is incorporated herein by reference in its entirety.

### BACKGROUND

The present disclosure relates to outdoor power equipment with an electrical starting motor and associated controls. More specifically, the present disclosure relates to an internal combustion engine having an electrical starting motor for starting the internal combustion engine.

Presently, many different types of outdoor power equipment include electronic starting circuits that allow the user to start the internal combustion engine of the outdoor power equipment through either a key switch or a push button. However, this often requires additional wiring and/or controls to be added to the outdoor power equipment. This can create additional cost and complexity when adding an internal combustion motor with electronic start to various outdoor power equipment applications.

### SUMMARY

The present disclosure relates to systems and methods for starting an internal combustion motor associated with outdoor power equipment, as described in the embodiments listed herein.

One embodiment of the invention relates to a lawn mower. The lawn mower includes an internal combustion engine, and an electric motor configured to start the internal combustion engine. The lawn mower further includes a brake mechanism and a release mechanism movable to an engaged position to release the brake mechanism. The lawn mower further includes a switch actuation by, the release mechanism, a pull rope, and a sensor configured to output a signal based on the pull rope being actuated. The lawn mower further includes a control module coupled to the switch and the sensor, wherein the switch is configured to provide inputs to the control module when the release mechanism is in the engaged position, and the sensor is configured to provide an input to the control module when the pull rope is actuated, and wherein the control module turns on the electric motor in response to the signals from the sensor and the switch.

Another embodiment of the invention relates to outdoor power equipment. The outdoor power equipment includes an internal combustion engine, an electric motor configured to start the internal combustion engine, and an implement driven by the internal combustion engine. The outdoor power equipment further includes a release mechanism movable to an engaged position to put the implement in a ready-to-run condition in which the implement is ready to be driven by the internal combustion engine. The outdoor power equipment further includes a switch actuated by the release mechanism and a sensor configured to detect actuation of a manual starting mechanism. The outdoor power equipment further includes a control module coupled to the switch and the sensor so that the switch provides a signal to the control module when release mechanism is in the engaged position, and the sensor provides a signal indicating actuation of the manual starting mechanism. The control module is further configured to turn on the electric motor to start the internal combustion engine in response to the signal from the switch and the sensor both being provided to the control module.

Another embodiment of the invention relates to a method of starting an internal combustion engine. The method includes receiving a first signal at a control module indicating that a release mechanism has been actuated and receiving a second signal at the control module indicating that a pull rope of the internal combustion engine has been pulled by at least a predetermined distance. The method further includes energizing an electric starting motor to start the internal combustion engine based on receiving the second signal after the first signal has been received, and where the first signal is still present at the control module when the second signal is received by the control module.

Another embodiment of the invention relates to a method of starting an internal combustion engine. The method includes detecting movement of a starter rope coupled to the internal combustion engine, detecting the status of an operator presence sensor, and activating an electric starter motor selectively coupled to the internal combustion engine based on receiving the second signal after the first signal has been received, and where the first signal is still present at the control module when the second signal is received by the control module.

Various other features, objects and advantages of the invention will be made apparent from the following description taken together with the drawings.

### BRIEF DESCRIPTION OF THE DRAWINGS

The disclosure will become more fully understood from the following detailed description, taken in conjunction with the accompanying figures, in which:

FIG. 1 illustrates a piece of outdoor power equipment in the form of a lawn mower, according to an exemplary embodiment;

FIG. 2 is a block diagram of a starting system associated with an internal combustion engine, according to some embodiments;

FIG. 3 is a top view of a rewind assembly including a pull rope sensor, according to some embodiments;

FIG. 4 is an electrical schematic illustrating a pull rope sensor latching circuit, according to some embodiments;

FIG. 5 is an electrical schematic illustrating a starting control system of an internal combustion engine, according to some embodiments; and

FIG. 6 is a flow chart illustrating a process for starting an internal combustion engine, according to some embodiments.

### DETAILED DESCRIPTION

The present disclosure is directed to a starting system for an internal combustion engine used with various types of outdoor power equipment. The drawing figures depict the use of the intelligent battery pack with a lawn mower. However, it should be understood that the battery pack and starting system could be utilized with other types of outdoor power equipment such as riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, over-seeders, power rakes, aerators, sod cutters, brush mowers, sprayers, spreaders, etc.

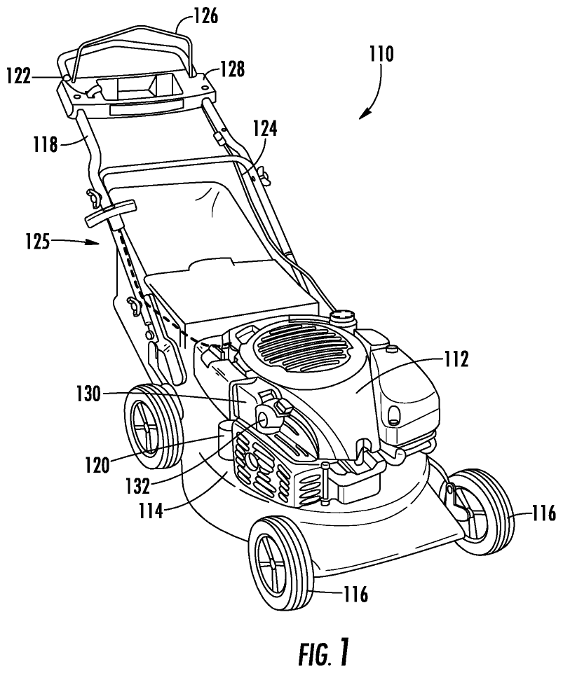

FIG. 1 illustrates a piece of outdoor power equipment, in the form of a lawn mower 110, which includes an internal combustion engine 112 coupled to a rotary tool, such as the blade in a deck of the lawn mower 110, an auger, a saw, tines, a drill, a pump, or other rotary tools. In some embodiments, the lawn mower 110 further includes wheels 116 and a rearward extending handle 118 designed to be pushed by an operator walking behind the lawnmower 110. In other contemplated embodiments, the outdoor power equipment may be in the form of a rotary tiller, a pressure washer, a snow thrower, a lawn tractor or riding mower, an edger, a portable generator, or other equipment, with a corresponding powered tool, such as tines, a pump, an auger and impeller, an alternator, a drive train, or other tools.

Still referring to FIG. 1, the lawn mower 110 includes a starter system. According to one embodiment, the starter system includes an electric motor 120 that is selectively coupled to the engine 112 such that the electric motor 120 is configured to rotate the crankshaft of the engine 112 to start the engine 112 and is configured to disengage once the engine 112 is running (e.g. operating above a predetermined RPM). In some embodiments, the motor 120 is fastened to the engine 112, such as being mounted on top of or to a side of the engine 112. Gearing (e.g. gear reduction, transmission, etc.) may extend between the motor 120 and the crankshaft of the engine 112, or the motor may be connected directly to the crankshaft of the engine 112. The starter system may further include a battery and a control module, which will be described in more detail below. The lawnmower 110 may further include a pull rope 125. The pull rope 125 may be coupled to a rewind assembly of the lawnmower 110, which in turn may be coupled to crankshaft of the engine 110, such that when an operator pulls the pull rope, motion is imparted to the crankshaft to facilitate starting of the engine 112.

In some embodiments, the starter system is integrated with a bail 126 of the lawn mower 110. A brake mechanism (e.g., friction brake, ignition interrupt switch or circuit, etc.) may be holding the blade or other tool, locking the crankshaft of the engine 112, or otherwise preventing operation of the power equipment. As such, releasing of the brake mechanism eases operation of the lawn mower 110 or other outdoor power equipment by reducing the steps necessary for activation. Furthermore. and as will be discussed in more detail below, a second input, such as actuation of the pull rope 125 may further be used to start the engine 112, in combination with the actuation of the bail

In general, integration of the starter system with a handle of outdoor power equipment allows the operator to start the engine from the rear of the outdoor power equipment, such as several feet from the powered tool of the outdoor power equipment (e.g. snow thrower auger, lawn mower blades). Further, the integration supports an electronic starting system for a walk behind mower that can be engage by a user without actuation of a key or push-button.

According to some embodiments, the starter system further includes an energy storage device 130 (e.g. a battery, capacitor, etc.) and a controller 132, The energy storage device 130 may include one or more batteries (e.g. lead acid, NiCd, Li-Ion, etc.), capacitors (e.g. super capacitors), or other devices. The batteries may be removable batteries. In some embodiments, the batteries may be power tool batteries configured to be received in a receiver mounted to the internal combustion engine 112 or the lawn mower 110. In one embodiment, the energy storage device 130 may be located on the internal combustion engine 112. In other embodiments, the energy storage device 130 may be located on the lawn mower 110. When the operator engages the starter system, the linkage 124 communicates one input to controller 132, either directly or indirectly. Similarly, and as will be discussed in more detail below, a second input signal may be provided to the controller 132, either directly or indirectly, when the user further engages the pull rope 125. The controller may then electrically connect the energy storage device 130 to power the starter motor 120. In some embodiments, the controller 132 is further coupled to one or more sensors within the engine 112 (e.g. a speed sensor, an ignition sensor, etc.), and may be configured to disengage the motor 120 (e.g. cuts power to the motor 120 via high-side switching of the electrical power source 130, and/or low-side switching of the ground or common side of the electrical power source 130) when it is determined by the controller 132 that the engine 112 is running at a sufficient speed.

In some embodiments, the motor 120, the energy storage device 130, and the controller 132 are fastened directly to the engine 112, which may be configured for efficient assembly of outdoor power equipment using the engine 112. As such, the starter system in some embodiments may come fully assembled with the engine 112, and ready for connection to a linkage configured to provide a signal from the handle (e.g., linkage 124). Accordingly, the manufacturer need only attach the engine 112 to the deck or corresponding feature and attach the tool to the power takeoff of the engine. In any such case, considerable time and effort may be saved during the manufacturing process and a potential source of manufacturing difficulty may be removed (i.e., that associated with the fastening and electrical connection of the components of the starter system during assembly of the outdoor power equipment). In still other embodiments, some or all of the starter assembly may be fastened to the deck of a lawn mower or corresponding feature of other power equipment.

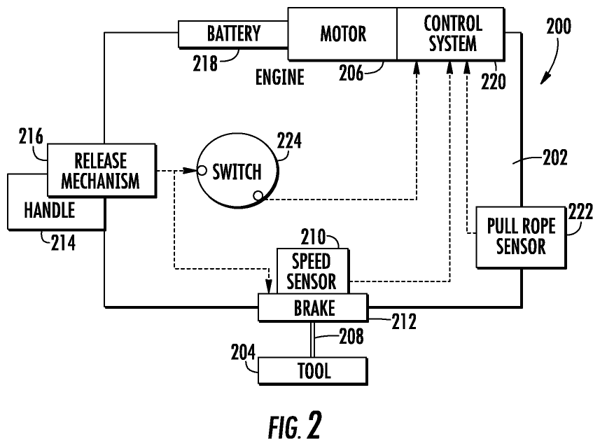

Referring to FIG. 2, outdoor power equipment 200 (shown schematically) includes an engine 202 and a powered tool 204 (e.g. a rotary blade) driven by the engine 202. In some embodiments, a motor 206 is coupled to the engine 202, and the powered tool 204 is coupled to a power takeoff 208 of the engine. A speed sensor 210 (e.g., governor) may be coupled to the engine 202 to regulate the speed of the engine 202. Also, a brake 212 may be coupled to a rotary member of the outdoor power equipment 200, such as the flywheel of the engine 202, the power takeoff 208 of the engine 202, etc., to stop the engine as well as the associated power tool 204.

In some embodiments, the outdoor power equipment 200 includes a handle 214 having a release mechanism 216, where the release mechanism 216 is configured to allow a user to release the brake 212 from the handle 214. The release mechanism 216 may allow a user to release the brake 212 by engaging the bail (or other element) with a linkage connected to the brake 212, or by disengaging an element blocking movement of the bail. The handle 214 may be coupled to the engine 202 and tool 204 directly, or via an intermediary member (e.g., deck 114 as shown in FIG. 1). The engine 202 may further include a battery 218 for powering the motor 206 and a control system 220 for operating the motor 206.

According to one embodiment, the outdoor power equipment 200 may further include a pull rope sensor 222. The pull rope sensor 222 is configured, to monitor a movement of the pull rope (e.g. pull rope 125 in FIG. 1). The pull rope sensor 222 may further be configured to provide an input to the control system 220 indicating that the operator has actuated the pull rope. In some embodiments, the pull rope sensor 222 may be configured to provide an input to the control system 220 when the pull rope is actuated by a predetermined or minimal amount. For example, in some embodiments, the operator may only need to pull the pull rope approximately four inches for the pull rope sensor 222 to register movement of the pull rope and provide a signal to the control system 220. However, other pull lengths of more than four inches or less than four inches are also contemplated. For example, other pull lengths may include a length of less than two feet, less than one foot, or less than six inches. However, other pull lengths are contemplated. By only requiring the operator to pull the pull rope a minimal fraction of a normal pull start engine, the operator is not required pull the pull rope as in a normal pull-start based engine. In some embodiments, a visual indicator, such as color stripes, tape, text or other visual markings may provide an indication to the operator as to the exact amount of pull of the pull rope needed to start the internal combustion engine 202.

In some embodiments, the pull rope sensor 222 may be a hall effect sensor. The hall effect sensor may be configured to detect the passing of one or more magnets on a rewind assembly. Thus, when the operator pulls the pull rope, causing the rewind assembly to rotate, thereby passing the one or more magnets within the fixed position of the hall effect sensor. In some embodiments, the one or more magnets may be embedded into the rewind assembly.

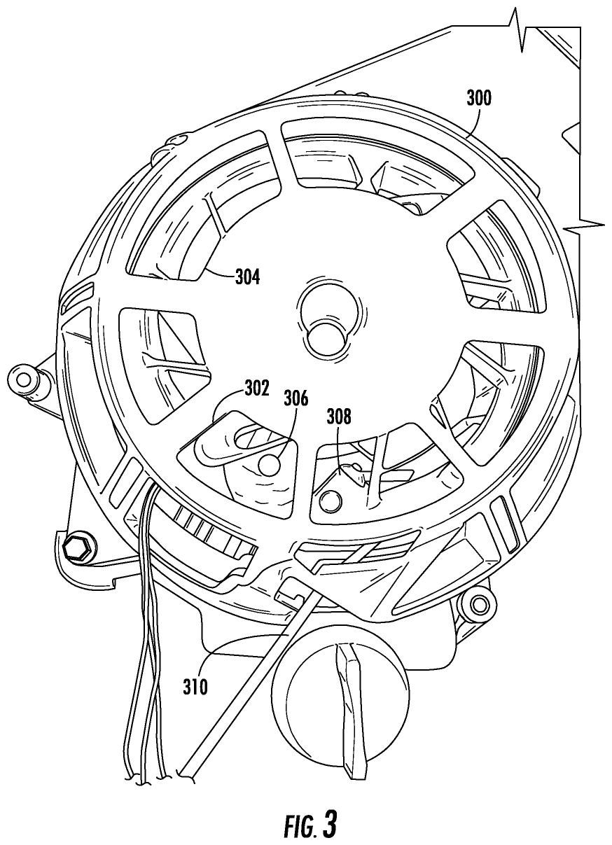

Turning to FIG. 3, a photograph illustrating, an example implementation of the above hall effect sensor assembly is shown, according to some embodiments. Shown in FIG. 3 is a rewind assembly 300 associated with a pull start mechanism of an internal combustion engine. A hall effect sensor 302 is attached in a stationary position on a housing 304 of the rewind assembly 300. A magnet 306 is attached to a rotating portion 308 of the rewind assembly 300. When an operator actuates (e.g. pulls) a pull rope 310, the rotating portion 308 of the rewind assembly is caused to rotate, thereby passing the magnet 306 by the hall effect sensor 302. The hall effect sensor 302 may then generate a signal which can be provide to a control system, such as control system 220. While the system in FIG. 3 is shown with only a single magnet 306, it is contemplated that multiple magnets could be installed onto the rotating portion 308 of the rewind assembly 300 to reduce the amount that the operator would have to pull the pull rope 310. In other embodiments, a magnet ring, having magnets of alternating polarity may be installed onto the rotating portion 308 of the rewind assembly 310. The hall effect sensor 302 may then detect a change in polarity as the magnets pass by and send a corresponding signal to a control system.

While FIG. 3 illustrates one embodiment wherein a magnet and hall effect sensor are used to generate a signal to the control system, other methods and system are also contemplated. For example, in one embodiment, one or more contact switches may be placed within the rewind assembly such that when the rotating portion moves due to an operator actuating the pull rope 310. For example, contact sensors may be placed on one or more contact surfaces within the rewind assembly that come into contact during rotation of the rewind assembly. In other examples, an optical sensor may be used to determine that the pull rope has been actuated. For example, an optical sensor may be placed in a location similar to that of the hall effect sensor 302. The optical sensor may then detect movement of the rotating portion 308 of the rewind assembly 300. In some embodiments, optical markings, such as alternating black and white colors, may be located on the rotating portion 308 of the rewind assembly 300 to provide an indication to the optical sensor that the pull rope 310 has been actuated (e.g. the optical sensor can detect the change in colors as the rotating portion 308 rotates.

In other embodiments, an optical sensor may be positioned to detect a movement of the pull rope 310. For example, the pull rope 310 may be configured to have an alternating color pattern which can be detected by the optical sensor. Optical sensors may include, photodiodes, photoelectric sensors, image sensors, optical switches, camera (e.g. CCD, CMOS, etc.) sensors, or other applicable optical sensors. In other embodiments, a magnet may be embedded in the pull rope 308. The pull rope may then be configured to run through an aperture which can detect the magnetic field and provide a signal to the control system. Other sensors or devices, such as switches, pressure sensors, centrifugal motion sensors, infrared sensors, time of flight sensors, and/or other sensors which can detect a pull of the pull rope by the operator.

Returning now to FIG. 2, it is contemplated that in one embodiment, the control system 220 associated with the starter system is configured to receive inputs associated with the release mechanism 216 and the pull rope sensor 222. In some embodiments, when the release mechanism 216 is actuated to release the brake 208, the release mechanism 216 triggers a switch 224, which provides an input to the control system 220 that is indicative of the release of the brake 212, The signal may be provided via a mechanical linkage, wirelessly, a hardwired electrical connection, or otherwise. Once the operator has engaged the release mechanism 216, the operator may then pull a pull rope by an amount such that the pull rope sensor 222 detects the actuation of the pull rope, as described above. The pull rope sensor may then provide an input to the control system 220 indicating that the operator has actuated the pull rope. In some embodiments, the control system 220 may then actuate the motor 206 to start the engine 202 or uses the information in control logic configured to start the engine as a function of the status of the release mechanism 216 and the pull rope sensor 222. Thus, the operator may be able to start the engine 202 by actuating the release mechanism 216 and then pulling the pull rope by an amount to actuate the pull rope sensor 222.

According to some embodiments, the control system 220 is configured to receive additional inputs from the speed sensor 210 or another component of the engine 112 (e.g., the ignition circuit). The speed sensor 210 or other component provides the control system 222 with information associated with the speed of the engine 112. When the engine 112 is running at a sufficient speed, the control system 222 then disengages the motor 206 (e.g., turns off, disconnects, cuts power to, etc.).

In further embodiments, the control system 222 associated with the start system may receive additional or different inputs used to control starting of the engine, such as, input from a sensor configured to indicate whether the outdoor power equipment has moved recently. Movement of an axle or wheels of such outdoor power equipment may trigger a sensor that provides a signal to the control system. The signal, in combination with an electric timer providing time-related context for the movement, may serve as an additional indicator that the operator intends to activate the engine 202. In other embodiments, the control system 222 in includes a tinier and is configured to deactivate the motor 206 if the engine has not started within a predetermined amount of time. In some contemplated embodiments, the control system 222 includes a temperature sensor and is configured to prime the engine with an automated primer pump or adjust the choke or throttle plate if ambient temperature is above or below a predetermined temperature, if a portion of the engine is above or below a predetermined temperature, or if the difference between ambient and engine temperature is above or below a predetermined, value. In still other embodiments, the control system 222 may also provide a signal output to the operator, such as a visible indicator on a display coupled to the handle or engine, or an audible alert. In some embodiments, the signal output may include an error message, a low-fuel message, a replace-oil message, or another such message.

In some embodiments, a motor, such as motor 206 may be configured to assist the operator in actuating the pull rope. For example, when actuation of the pull rope is detected, as described above, the motor 206 may be configured to actuate to provide additional force to the crank shaft, thereby reducing the effort required by the operator pulling the pull rope. This can allow for a smaller staring motor and associated battery to be used, while still increasing the ease of starting the outdoor equipment.

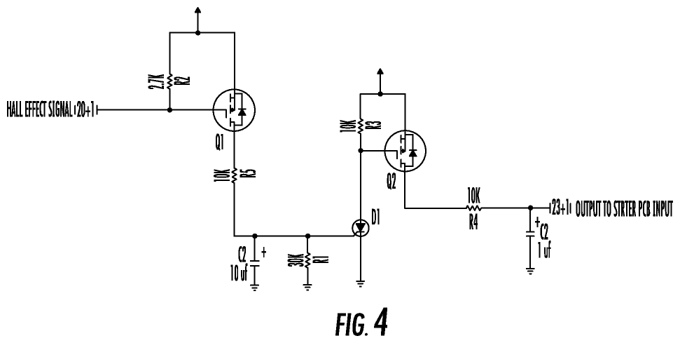

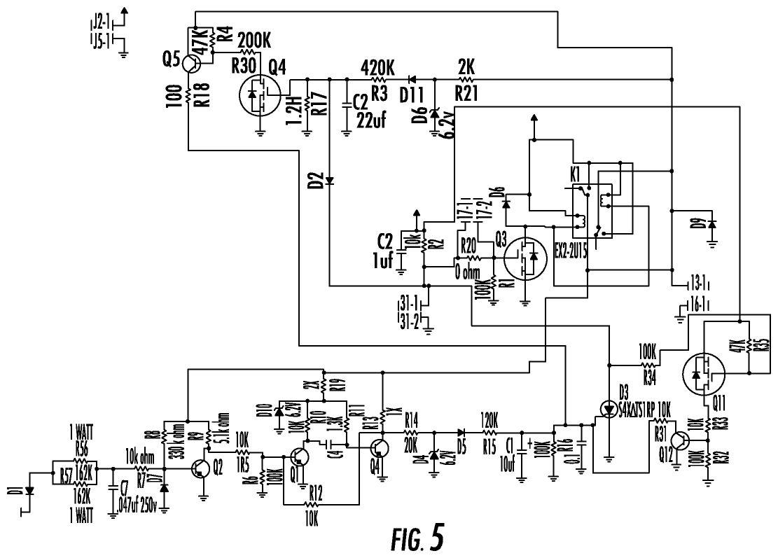

According to some embodiments, the circuits of FIGS. 4 and 5 are contained on circuit boards that are integrated with the engine (see, e.g., controller 132 as shown in FIG. 1), and may be fully powered by the battery or other on-board source. Accordingly, the circuits may require no electrical interface to components of the lawn mower or other outdoor power equipment aside from those carried by or integrated with the engine. No additional wiring or connections may be required. Accordingly, the assembly process for the associated outdoor power equipment may be improved, as discussed above.

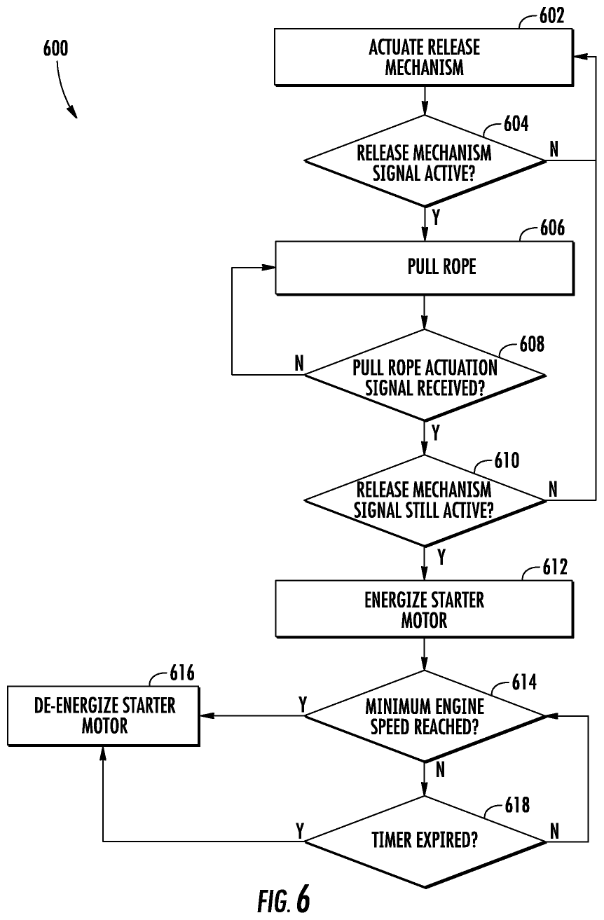

Turning now to FIG. 6, a process 600 for starting an internal combustion engine coupled to an outdoor power equipment is shown, according to some embodiments. At process block 602, an operator actuates a release mechanism (e.g. a bail) on the outdoor power equipment, at process block 604, it is determined whether the release mechanism actuation signal is active (e.g. has the release mechanism been actuated). In some embodiments, the release mechanism actuation signal may be provided to a control system (e.g. control, system 222) as described above. If the release mechanism activation signal is not active, the process returns to process block 602 to await actuation of the release mechanism. If the release mechanism activation signal is active, the pull rope is actuated at process block 606. For example, once an operator has actuated the release mechanism, the operator may then actuate (e.g. pull) the pull rope. The process then determines if the pull rope signal is received by the control system at process block 608. The pull rope signal may be generated and provided to a control system as described above. If the pull rope signal is not received, the process returns to process step 606 to monitor for the pull rope signal to be received. If the pull rope signal is determined to be received at process block 608, it is determined if the bail activation signal is still active at process block 610. If the release mechanism activation signal is no longer active, the process returns to process block 602 to monitor for activation of the release mechanism.

If the release mechanism activation signal is determined to still be active at process block 610, the starter motor is energized at process block 612. At process block 614 the process determines if a minimum speed of the engine has been reached. In one embodiment, the minimum speed may be 1000 RPM. However, minimum speed values of more than 1000 RPM or less than 1000 RPM are also contemplated. If the minimum speeds have been reached, the starter motor is stopped at process block 616, as described above. If the minimum speed is determined to not have been reached at process block 614, the system then determines if a timer has expired at process block 618. In one embodiment, the timer may be five seconds. However, in other embodiments, the timer may be more than five seconds or less than five seconds, as applicable. In some examples, the timer value is determined based on a rating of the starting motor and/or battery. If the timer is determined not to have expired, the process returns to process block 614.

This written description uses examples to disclose the invention, including the best mode and to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. An apparatus, comprising:
an internal combustion engine;
an electric motor configured to start the internal combustion engine;
a brake mechanism;
a release mechanism movable to a first position to release the brake mechanism;
a switch actuated by the release mechanism;
a pull rope;
a sensor configured to output a signal based on the pull rope being actuated; and
a control module coupled to the switch and the sensor;
wherein the switch is configured to provide a switch input to the control module when the release mechanism is in the first position;
wherein the sensor is configured to provide a sensor input to the control module when the pull rope is actuated;
wherein the control module activates the electric motor in response to the switch input and the sensor input.

2. The apparatus of claim 1, further comprising a rewind mechanism attached to the internal combustion system, the rewind mechanism having a stationary portion and a rotating portion, wherein the rotating portion is configured to rotate based on the pull rope being actuated.

3. The apparatus of claim 2, wherein the sensor is coupled to at least one of the stationary portion and the rotating portion and is configured to detect a movement of the rotating portion relative to the stationary portion.

4. The apparatus of claim 3, wherein the sensor is a hall effect sensor, and further wherein one or more magnets are installed on the rotating portion, such that a magnetic field associated with the magnets is detected by the hall effect sensor as the one or more magnets rotate past a location of the hall effect sensor, the hall effect sensor configured to generate the input, to the control module based, on the detected magnetic field.

5. The apparatus of claim 3, wherein the sensor is an optical sensor configured to detect a rotation of the rotating portion, and the optical sensor is further configured to provide the input to the control module based on the detected rotation.

6. The apparatus of claim 3, wherein the sensor is a microswitch configured to detect a rotation of the rotating portion.

7. The apparatus of claim 1, further comprising a speed sensor configured to detect when the internal combustion engine is running at a threshold speed, wherein the engine speed sensor is coupled to the control module, and wherein the control module turns off the electric motor when the engine speed sensor detects the threshold speed.

8. The lawn mower of claim 7, wherein the internal combustion engine includes an ignition coil and the engine speed sensor is coupled to the ignition coil to detect an ignition signal.

9. Outdoor power equipment, comprising:
an internal combustion engine;
an electric motor configured to start the internal combustion engine;
an implement driven by the internal combustion engine;
a release mechanism movable to an engaged position to put the implement in a ready-to-run condition in which the implement is ready to be driven by the internal combustion engine; a switch actuated by the release mechanism; a sensor configured to detect actuation of a manual starting mechanism; and
a control module coupled to the switch and the sensor so that the switch provides a signal to the control module when the release mechanism is in the engaged position, and the sensor provides a signal indicating actuation of the manual starting mechanism, the control module configured to turn on the electric motor to start the internal combustion engine in response to the signal from the switch and the sensor both being provided to the control module.

10. The outdoor power equipment of claim 9, wherein the manual starting mechanism comprises a rewind assembly having a rotating portion, a stationary portion, and a pull rope, wherein the rotating portion is configured to rotate when the pull rope is pulled.

11. The outdoor power equipment of claim 10, wherein the sensor is coupled to the stationary portion of the rewind assembly and configured to detect a motion of the rotating portion.

12. The outdoor power equipment of claim 11, wherein the sensor is a hall effect sensor.

13. The outdoor power equipment of claim 12, wherein one or more magnets are coupled to the rotating portion such that when the rotating portion is rotated, the magnets pass in close proximity to the hall effect sensor, and wherein the hall effect sensor is configured to detect the magnets and generate the signal provided to the control module.

14. The outdoor power equipment of claim 10, wherein the pull rope comprises an one or more magnets embedded in the pull rope, and wherein the pull rope passes through a wire coil such that the magnets generate an electrical signal when the rope passes through the coil which is detected by the sensor and provided to the control module.

15. The outdoor power equipment of claim 10, wherein the outdoor power equipment comprises at least one of a lawn mower, riding tractor, snow thrower, pressure washer, tiller, log splitter, zero-turn radius mower, walk-behind mower, riding mower, stand-on mower, pavement surface preparation device, blower, vacuum, debris loader, overseeder, power rake, aerator, sod cutter, brush mower, sprayer, and spreader.

16. A method of starting an internal combustion engine, comprising:
detecting movement of a starter rope coupled to the internal combustion engine;
detecting the status of an operator presence sensor;
activating an electric starter motor selectively coupled to the internal combustion based on detecting movement of the starter rope and detecting the status of an operator presence sensor.

17. The method of claim 16, wherein detecting movement of starter rope comprises detecting movement of starter pulley coupled to starter rope.

18. The method of claim 16, wherein the electric starter motor is activated based on detecting a movement of the starter rope corresponding to at least one of less than 2 feet, less than 1 foot, and less than 6 inches.

19. The method of claim 16, wherein the electric starter motor is activated by selectively electrically connecting a battery to the electric starter motor.

20. The method of claim of 19, wherein the battery is at least one of a removable battery, a removable battery coupled to the engine, and a power tool battery.
